(19) United States
(12) Patent Application Publication
(10) Pub. No.: US 2017/0039647 A1
(43) Pub. Date: Feb. 9, 2017

(54) System and Method of Automating Trades in Personal Accounts Based on Trading Directives by a Trading Advisory Service Provider

(71) Applicant: Bruno Bottarelli, Naperville, IL (US)

(72) Inventor: Bruno Bottarelli, Naperville, IL (US)

(21) Appl. No.: 15/228,763

(22) Filed: Aug. 4, 2016

Related U.S. Application Data
(60) Provisional application No. 62/200,738, filed on Aug. 4, 2015.

(51) Int. Cl. G06Q 40/04; G06Q 40/02

(52) U.S. Cl. CPC G06Q 40/04; G06Q 40/02

(57) ABSTRACT

A computer-implemented method and system of automatically executing trades based upon trading directives issued by a trading service provider to which a user is subscribed. The system includes receiving a trading directive that is transmitted from the trading service provider. The trading directive includes a transaction of a financial instrument. The trading directive is effectuated via an interface, e.g. an API, with an electronic trading platform to which a core account, operated by the trading service provider, and subscribers' accounts are linked. The API executes the financial transaction in the core account and simultaneously replicates the financial transaction in the subscribers' accounts, thereby allowing the distribution of financial instruments held by the subscribers to track the changing distribution of financial instruments held by the trading service provider without the need to manually manage the trades and while maintain capital in their own trading accounts.

### CROSS REFERENCE TO RELATED APPLICATIONS

This application claims the benefit of U.S. Provisional Application No. 62/200,738 filed on Aug. 4, 2015. The above identified patent application is herein incorporated by reference in its entirety to provide continuity of disclosure.

### BACKGROUND OF THE INVENTION

The present invention relates to systems and methods in the process of managing investment activity. More specifically, the present invention relates to systems and methods of automating trades in multiple personal accounts based on information provided by a trading advisory service provider.

Individual investors seeking a return on an investment must, at great time and expense, acquire the sophisticated knowledge, expertise, and skill to efficiently trade in fast moving markets. They execute trades manually in their individual accounts while focusing relentless attention to market movements in order to make a profit. Individual investors without the requisite trading skill can only participate in these lucrative fast moving markets by investing their capital in professionally managed investment funds. There exists a need for a system and method that can allow individuals to place professionally executed options, commodity, futures, currency or other sophisticated fast-paced market trades in their individually owned trading accounts directly, without entrusting their capital to a managed investment fund.

### SUMMARY OF THE INVENTION

In view of the foregoing disadvantages inherent in the known types of automated trading systems now present in the prior art, the present invention provides a computer-implemented method and system of automatically executing trades based upon trading directives issued by a trading service provider to which a user is subscribed. The system includes receiving a trading directive that is transmitted from the trading service provider. The trading directive includes a transaction of a financial instrument. The trading directive is effectuated via an interface, e.g. an API, with an electronic trading platform to which a core account, operated by the trading service provider, and subscribers' accounts are linked. The API executes the financial transaction in the core account and simultaneously replicates the financial transaction in the subscribers' accounts, thereby allowing the distribution of financial instruments held by the subscribers to track the changing distribution of financial instruments held by the trading service provider without the need to manually manage the trades and while maintain capital in their own trading accounts.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of an illustrative embodiment of the present system.

FIG. 2 shows a flowchart of an illustrative embodiment of a method of executing trades in a core trading account and subscribers' accounts utilizing the present system.

### DETAILED DESCRIPTION OF THE INVENTION

Reference is made herein to the attached drawings. Like reference numerals are used throughout the drawings to depict like or similar elements of the system and method of automating trades in personal accounts based on information provided by a trading advisory service provider. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

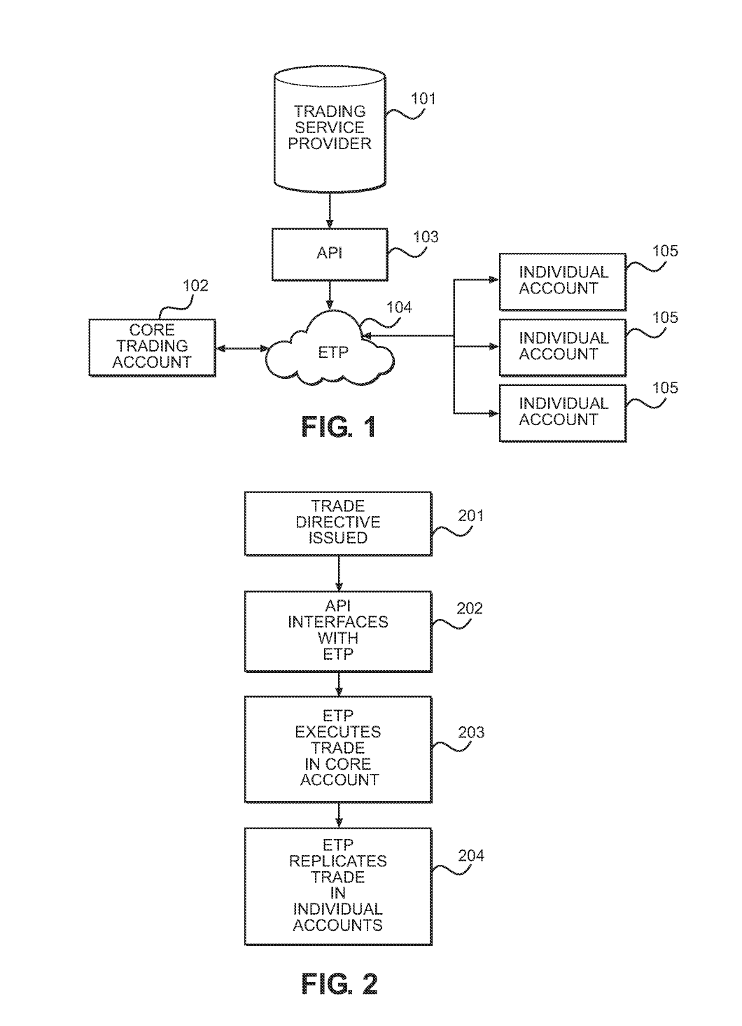

Referring now to FIG. 1, there is shown a diagram of an illustrative embodiment of the present system. The present system is designed to allow individuals to tap into the knowledge and experience of more sophisticated professional traders by replicating the market trades of sophisticated professional traders via a system configured to interact with and execute trades through an electronic trading platform (ETP), e.g. an API-enabled system. In an illustrative embodiment, the system includes a trading service provider 101 that is configured to issue trading directives via an interface, e.g. a web-enabled application program interface (API) 103 as depicted in FIG. 1, to an ETP 104. In alternative embodiments, the interface includes a feed, e.g. XML or RSS, or any other appropriate means for an ETP to receive trading directives. As used herein, “trading directive” refers to data transmitted via a communications network, e.g. the Internet, that includes instructions to execute a transaction, e.g. a purchase or sale, of at least one financial instrument either as a single instance or as a persistent set of instructions to be carried out over a period of time.

The trading service provider 101 includes a server that enables trading directive to be issued via the API 103, which interfaces with the ETP 104 and then executes the instructions thereof. The ETP 104 is a system that is configured to communication with an exchange or multiple exchanges over a network and execute trades of financial instruments over the exchanges via an interface, e.g. a web-enabled interface into which users can log in via a web browser. The API 103 communicates with the ETP 104 via a communications network, e.g. the Internet. The API 103 embodies a logic, e.g. computer instructions, executable at least in part by a computer processor in order to execute trading directives issued by the trading service provider 101 across multiple accounts in communication with the ETP 104.

An illustrative embodiment of the system further includes a core trading account 102, which is managed by the trading service provider 101, and one or more subscribers' accounts 105, which are the personal trading accounts of the clients or licensees of the trading service provider 101, in communication with the ETP 104. Each time the trading service provider 101 issues a trading directive, the ETP 104 executes a transaction or trade in the core trading account 102 and simultaneously replicates the transaction or trade executed in the core trading account 102 in each of the subscribers' accounts 105. For each trade, the API 103 transmits at least the identity of the financial instrument that is the subject of the transaction and the value of the transaction to the ETP 104. In some embodiments of the present system, the API 103 additionally transmits the price of the financial instrument and other such information relating to the transaction. Because fast-moving transactions of financial instruments, such as high-frequency trading, are executed much too quickly to be processed manually, individual traders are shut out from participating in such transactions. Through linking their individual accounts 105 to the trading service provider 101 via the API 103 so that such trades are executed in their individual accounts 105 automatically, subscribers to the trading service provider 101 can benefit from high-frequency trading strategies utilized by the trading service provider 101.

In the depicted embodiment of the present system, the API 103 is in communication with a single ETP 104, which is in turn in communication with both the core trading account 102 and each of the subscribers' accounts 105. However, in alternative embodiments of the present system, the API 103 could be in communication with multiple separate ETPs 104 that are each configured to interface with the API 103.

Referring now to FIG. 2, there is shown a flowchart of an illustrative embodiment of a method of executing trades in a core trading account and subscribers' accounts utilizing the present system. Clients can utilize the present system by linking their personal trading accounts in the ETP to the present system via the API of the trading service provider. By doing so, any trade directives issued by the trading service provider are automatically implemented in the subscribers' personal accounts, which allows the individual traders to implement trading strategies generally only available to institutional investors, e.g. high-frequency trading to take advantage of short-term, fluctuating market conditions, and directly and automatically execute the trading recommendations of the trading service provider without the need to manually execute the trades.

The trading service provider issues 201 a trading directive, which is received and processed by the API. After processing the trading directive, the API then interfaces 202 with the ETP in order to effectuate the instructions of the trading directive through the ETP to which the core account and the subscribers' accounts are connected. Once interfaced with the API, the ETP then executes 203 the transactions dictated by the trading directive processed by the API in the core trading account and simultaneously executes 204 transactions in each of the subscribers' accounts that replicate the trade in the core trading account. The transactions include purchase orders, sell orders, stop-loss orders, and other such trades or financial transactions. The trading directive includes at least the identity of a financial instrument and a parameter to determine the monetary value or amount of the financial instrument to be purchased or sold. The parameter can include an absolute number of shares of the financial instrument, a proportional amount of the financial instrument to purchase relative to the funds available in the core trading account, a variable dependent upon intervening market fluctuations or other trading factors, or any other such parameter.

In an illustrative embodiment, the API includes an algorithm configured to automatically determine the value or amount of the trade to be executed in the core trading account and the subscribers' accounts based upon one or more factors, including the balance held in the core trading account and the subscribers' accounts, the amount of the financial instrument already held in the core account and subscribers' accounts, the length of time that the financial instrument has been held, the desired number of trades for the month, a parameter measuring market fluctuations, and any other such factors. In one embodiment of the system, the trading directive dictates a proportional amount of the financial instrument to purchase or sell. For example, if the trading directive dictates that 10% of available funds are to be used to purchase a financial instrument, then the API receives the amount of the available funds in each of the core trading account and the subscribers' accounts and then execute trades via the ETP to purchase enough shares of Stock A in each account such that 10% of the available funds in each account are spent on the financial instrument. After completion of the financial transaction, the API receives the balances of each of the accounts to store the amounts of funds in each of the accounts available for subsequent transactions. The algorithm of the API is thereby able to constantly tailor each transaction for each of the accounts depending upon the overall trading directive from the trading service provider, thereby ensuring that the distribution of financial instruments held in each of the subscribers' accounts matches proportionally aligns with the distribution of financial instruments held in the core account managed by the trading service provider. In the case of a sell order for an embodiment of the system, the proportional relationship maintained is the amount of the financial instrument sold relative to the amount of the financial instrument held.

The algorithm implemented by the API can also implement persistent trading directives from the trading service provider that are active for more than transient periods of time, rather than simply executing individual trades. This allows the system to provide clients with the benefit of a general persistent investment strategy or fund management, while simultaneously allowing the trading service provider to intervene and execute specific trades when desired. In the absence of specifically dictated trades from the trading service provider, the persistent trading directives can include automatically executing trades of financial instruments of a set size, at a set frequency, or based upon algorithmic trading concepts utilizing additional factors such as timing and the price of the financial instruments, as are commonly used in high-frequency trading. For example, a trading service provider may desire to automatically execute a set number of trades over a set time period of time, sell a financial instrument once a desired return has been reached, sell a financial instrument if the price falls to a threshold level in the manner of a stop-loss order, and so on.

In an illustrative embodiment, the algorithm of the API additionally tracks performance compared to a set return objective of the trading directive and returns this data to the trading service provider. By utilizing this data, the trading service provider can then take corrective action in order to meet return objectives.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A computer-implemented method comprising:
receiving a trading directive, the trading directive including a transaction of a financial instrument;
interfacing with an electronic trading platform;
executing the transaction of the financial instrument from a core trading account via the electronic trading platform; and
executing a replicating transaction of the financial instrument from one or more subscribers' accounts via the electronic trading platform, the replicating transaction proportional to the purchase from the core trading account.

2) The computer-implemented method of claim 1, further comprising:
returning an account balance of the core account; and
returning an account balance of each of the one or more subscribers' accounts.

3) The computer-implemented method of claim 1, wherein the transaction is a purchase order, the replicating transaction being proportional to a value of the purchase order relative to an account balance of the core account.

4) The computer-implemented method of claim 1, wherein the transaction is a sell order, the replicating transaction being proportional to a value of the sell order relative to a held amount of the financial instrument.

5) The computer-implemented method of claim 1, wherein the trading directive is a persistent order including a plurality of transactions of one or more financial instruments executed over a non-transient period of time.

6) The computer-implemented method of claim 1, wherein interfacing is effectuated via an API.

7) A computer system comprising:
a processor;
a non-transitory computer readable medium operably connected to the processor;
a logic that is at least partially stored in the non-transitory computer readable medium and that, when executed at least in part by the processor, causes the computer system to perform a method, the method comprising:
receiving a trading directive, the trading directive including a transaction of a financial instrument;
interfacing with an electronic trading platform;
executing the transaction of the financial instrument from a core trading account via the electronic trading platform; and
executing a replicating transaction of the financial instrument from one or more subscribers' accounts via the electronic trading platform, the replicating transaction proportional to the purchase from the core trading account.

8) The computer system of claim 7, wherein the method of the logic further includes:
returning an account balance of the core account; and
returning an account balance of each of the one or more subscribers' accounts.

9) The computer system of claim 7, herein the transaction is a purchase order, the replicating transaction being proportional to a value of the purchase order relative to an account balance of the core account.

10) The computer system of claim 7, wherein the transaction is a sell order, the replicating transaction being proportional to a value of the sell order relative to a held amount of the financial instrument.

11) The computer system of claim 7, wherein the trading directive is a persistent order including a plurality of transactions of one or more financial instruments executed over a non-transient period of time.

12) The computer-implemented method of claim 7, wherein interfacing is effectuated via an API.

13) A non-transitory computer readable medium that, when executed by a processor of a computer, causes the computer to perform a method, the method comprising:
receiving a trading directive, the trading directive including a transaction of a financial instrument;
interfacing with an electronic trading platform;
executing the transaction of the financial instrument from a core trading account via the electronic trading platform; and
executing a replicating transaction of the financial instrument from one or more subscribers' accounts via the electronic trading platform, the replicating transaction proportional to the purchase from the core trading account.

14) The non-transitory computer readable medium of claim 13, wherein the method of the logic further includes:
returning an account balance of the core account; and
returning an account balance of each of the one or more subscribers' accounts.

15) The non-transitory computer readable medium of claim 13, wherein the transaction is a purchase order, the replicating transaction being proportional to a value of the purchase order relative to an account balance of the core account.

16) The non-transitory computer readable medium of claim 13, wherein the transaction is a sell order, the replicating transaction being proportional to a value of the sell order relative to a held amount of the financial instrument.

17) The non-transitory computer readable medium of claim 13, wherein the trading directive is a persistent order including a plurality of transactions of one or more financial instruments executed over a non-transient period of time.

18) The non-transitory computer readable medium of claim 13, wherein interfacing is effectuated via an API.
